(19) United States
(12) Patent Application Publication
(10) Pub. No.: US 2012/0017720 A1
(43) Pub. Date: Jan. 26, 2012

(54) Bearing Expansion Lock

(75) Inventor: Brian Painter, Walsall (GB)

(73) Assignee: WYKO Tire Technology, Inc., Greenback, TN (US)

(21) Appl. No.: 13/188,611

(22) Filed: Jul. 22, 2011

Related U.S. Application Data
(63) Continuation of application No. 61/366,748, filed on Jul. 22, 2010.

(51) Int. Cl. G05G 5/06

(52) U.S. Cl. 74/527

(57) ABSTRACT

A bearing expansion lock useful in locking linear axial movement of a push-pull rod driven by a potential energy source, where the push-pull rod is housed in a hollow shaft, is disclosed. A hollow elongated housing is provided to be mounted along an axial dimension of the hollow shaft. A shaft subassembly is received within the housing and adapted to be interposed between an outboard end of the push-pull rod and the potential energy source. The shaft subassembly is reconfigurable between a first position in which the shaft subassembly is braced against slidable movement within the housing along the hollow shaft and a second position in which the shaft subassembly is slidable within the housing along the central shaft. Configuration of the shaft subassembly in the first position restricts movement of the shaft subassembly along the housing, thereby restricting movement of the push-pull rod along the hollow shaft.

### CROSS-REFERENCE TO RELATED APPLICATIONS

This application claims the benefit of U.S. Provisional Patent Application No. 61/366,748, filed on Jul. 22, 2010.

### STATEMENT REGARDING FEDERALLY SPONSORED RESEARCH OR DEVELOPMENT

Not Applicable

### BACKGROUND OF THE INVENTION

1. Field of Invention

This invention pertains to tire building equipment. More particularly, this invention pertains to a lock for locking a slidable member within a sleeve, the lock being useful, for example, in conjunction with an expandable and collapsible tire building drum for the manufacture of tires.

2. Description of the Related Art

Commonly, the process of manufacturing a tire, such as a motor vehicle tire, includes fabrication of a cylindrical carcass as a precursor to the tire. A tire carcass is formed by laying down components of the tire on the outer circumference of a rotatable, expandable and collapsible drum. Such drums must be adjustable with respect to their diameter, hence their outer circumference, first, to establish a desired outer circumference of the drum, and second, to collapse the drum for removing a completed carcass from the drum.

Adjustablility of the diameter of tire building drums commonly involves a plurality of segments which are moveable between radially collapsed positions internally of the drum and radially expanded positions in which the segments collectively define the outer circumference of the drum. U.S. Pat. No. 6,390,166 (“the '166 patent”), which patent is incorporated herein in its entirety by reference, discloses a tire building drum of this type. The device of the '166 patent includes generally a plurality of segments collectively defining the outer circumferential surface of a generally cylindrical drum. The segments are mounted by way of a system of linkages about a central main shaft which allows the segments to be selectively repositionable between expanded positions radially of the rotational axis of the drum and collapsed positions radially of the drum in which a portion of the segments are brought into overlying relationship with other of the segments to collapse the diameter of the drum. Positioning the segments in the expanded positions provides a relatively continuous circumferential outer surface of the drum, thereby permitting layup of various components of a tire carcass thereon for forming of the tire carcass. Positioning the segments in the collapsed positions collapses the diameter (and circumference) of the drum to permit the removal of a formed tire carcass from the drum.

In the device of the '166 patent, control of the selective repositioning of the segments between the expanded and collapsed positions is provided for by means of a push-pull rod which is received within a hollow outboard end of the main shaft and mounted therein for axial sliding movement relative to the main shaft. Reciprocatory movement of this push-pull rod activates other mechanism(s) internally of the drum to effect radial expansion and contraction of the segments of the drum. Accordingly, an outboard end of the push-pull rod is bored and tapped to be engaged by an actuating mechanism associated with a tire making machine of the type known in the art. This actuating mechanism functions to selectively move the push-pull rod axially within the main shaft to thereby effect radial adjustment of the segments and selection of the diameter (circumference) of the drum.

Once the tire building drum is expanded to its desired diameter, the moving parts of the tire building drum must be rigidified so that the segments will maintain their expanded state under the forces to which the tire building drum is subjected in the course of forming of the carcass. In several configurations of tire building drums and tire making machines of the type known in the art, the actuating mechanism for engaging and moving the push-pull rod of the tire building drum includes an external piston/cylinder which is powered by pressurized fluid to actuate the push-pull rod. There are large numbers of tire building drums in existence, and new tire building drums are being produced and introduced into the marketplace, wherein the tire building drum has no internal mechanism, other than the continued application of a force upon the push-pull rod by means of the pressurized fluid, for locking the segments in their most outwardly radial positions after the segments have been so positioned. In these tire building drums, failure to maintain the “push” pressure against the push-pull rod results in radial collapse of the segments thereby destroying the usefulness of the tire building drum. Moreover, in these latter tire building drums, should the value of the pressure applied to the push-pull rod diminish below that value which is required to maintain the segments in their fully expanded positions, for any reason, during the laying up of a tire component on the outer circumference of the tire building drum, the segments can collapse and destroy the component being formed.

Furthermore, in certain prior art tire building drums including the device of the '166 patent, the mechanical nature of the positioning, sizing, and assembly of a multiplicity of interacting components of the tire building drum results in a relatively small, but important, degree of lost motion when the direction of movement of the push-pull rod is reversed. As much as 0.7 inch of lost motion is not uncommon in the prior art tire building drums. Unless accommodated for, this lost motion can result in deleterious gaps between adjacent ones of the segments, hence variation in the circularity of the outer circumference of the tire building drum and a resulting non-circular tire component being formed on the tire building drum. Such non-circular components translate into noncircular tires that are unusable.

To accommodate this lost motion, it has been the practice to continue the application of pressure against the push-pull rod even after the segments have attained their desired full radially outwardly limit of movement, thereby maintaining the overall mechanical system in a degree of compression so that the segments are forced to remain in their most radially outward positions until a carcass or other tire component has been formed on the tire building drum and the diameter of the tire building drum is to be reduced for removal of the formed component. This action ensures that the outer circumference of the tire building drum remains uniformly circular i.e., without gaps between adjacent segments throughout the formation of a vehicle tire component, such as a torodial tire carcass, thereby ensuring that the resulting carcass is of the desired final uniform internal diameter and of uniform toroidal geometry.

In the device of the '166 patent and other like tire building drums, most commonly, the expansion force for the tire building drum segments is pressurized air. Maintenance of the expanded state of these tire building drums, i.e., locking of the tire building drum in its expanded state, is by maintaining pressurized air against the moving elements of the tire building drum for the duration of that time within which a carcass or other tire component is being formed on the tire building drum. However, such continued application of force against the push-pull rod introduces the potential for developing destructive forces should one or more of the components of the tire building drum fail while in compression. Thus, such pressurized air “locking” of the drum has been suggested to be a potential safety hazard for operators of the equipment under certain operating circumstances and especially in the event of catastrophic failure of one or more of the mechanical components of the tire building drum.

### BRIEF SUMMARY OF THE INVENTION

The present general inventive concept is useful for example in locking axial movement of a push-pull rod driven by a potential energy source suitable for effecting linear axial movement of the push-pull rod, where the push-pull rod is housed in a hollow shaft. According to one embodiment of the present general inventive concept, a bearing expansion lock is provided which includes a hollow elongated housing adapted to be mounted along an axial dimension of the hollow shaft. A shaft subassembly is received within the housing and is adapted to be interposed between an outboard end of the push-pull rod and the potential energy source. The shaft subassembly is generally reconfigurable between a first position in which the shaft subassembly is braced against slidable movement within the housing along the hollow shaft and a second position in which the shaft subassembly is slidable within the housing along the central shaft. Configuration of the shaft subassembly in the first position restricts movement of the shaft subassembly along the housing, thereby restricting movement of the push-pull rod along the hollow shaft.

In one embodiment of the general inventive concept, the shaft subassembly includes a shaft having an inboard end and an outboard end. The shaft inboard end is adapted to be secured to the push-pull rod. A circumferential flange extends from the shaft between the shaft inboard and outboard ends. One embodiment of the general inventive concept further includes a ball cage defining a plurality of through cavities. Each through cavity has a ball bearing at least partially embedded therein. The ball cage is slidably disposed along the shaft between the first position, in which the flange engages at least one of the ball bearings to bias the ball bearing toward the housing, and the second position, in which the flange is disengaged from the ball bearings. In one embodiment of the general inventive concept, the plurality of through cavities are disposed in an annular array about the ball cage surrounding the shaft.

In one embodiment of the general inventive concept, the shaft subassembly further includes an annular bushing surrounding the shaft with a first end extending between the shaft and the ball cage and a second end extending along the shaft opposite the ball cage from the flange. In one embodiment, a resilient assembly is disposed between the ball cage and the bushing second end. The resilient assembly is compressible between the ball cage and the bushing second end to bias the ball cage toward the flange to maintain engagement of the flange with the ball bearings in the first position. In one embodiment, the resilient assembly includes a resilient annular ring disposed surrounding the shaft between the ball cage and the bushing second end. In another embodiment, the resilient assembly includes a plurality of springs disposed surrounding the shaft between the ball cage and the bushing second end.

In one embodiment of the general inventive concept, separation of the ball cage from the bushing second end along the shaft is restricted. For example, in one embodiment, a collar is provided surrounding the resilient assembly to capture the resilient assembly between the ball cage and the bushing second end. In one embodiment, the collar is defined by a split collar surrounding the resilient assembly and limiting separation of the ball cage from the bushing second end along the shaft.

In one embodiment of the general inventive concept, the shaft subassembly further includes a cap having an inboard end secured to and surrounding the bushing second end and the shaft outboard end. An outboard end of the cap defines a connector adapted to secure the cap to the source of potential energy suitable for effecting linear axial movement of the push-pull rod. In one embodiment, the connector is defined by a neck portion integrally formed with the cap outboard end and a circumferential flange defined at a terminus of the cap outboard end. The cap is sized to allow intimate slidable engagement with an interior surface of the housing.

The shaft subassembly is adapted to be slidably received within the housing. In one embodiment, the housing interior surface defines a cylindrical shape, and the ball cage and collar are each sized to allow intimate slidable engagement with the interior surface of the housing.

In certain embodiments, the present general inventive concept is included in a rotatable drum useful in the manufacture of a vehicle tire or component thereof, wherein the drum includes a housing and a plurality of outer circumferential surface-defining segments which are radially positionable relative to the rotational axis of the drum by means including linear axial movement of a push-pull rod, housed within a central shaft, by a potential energy source suitable for effecting linear axial movement of the push-pull rod.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of a tire building drum including one embodiment of a bearing expansion lock constructed in accordance with several features of the present invention;

FIG. 2 is a cross-sectional side view of the tire building drum and bearing expansion lock of FIG. 1;

FIG. 3 is a partial cross-sectional side view of the tire building drum of FIG. 2, showing a close up view of the bearing expansion lock;

FIG. 4 is an exploded perspective view of the bearing expansion lock of FIG. 2;

FIG. 5 is an exploded cross-sectional side view of the bearing expansion lock of FIG. 2;

FIG. 6 is a cross-sectional side view of the bearing expansion lock of FIG. 2, showing the bearing expansion lock in the first position;

FIG. 7 is a cross-sectional side view of the bearing expansion lock of FIG. 2, showing the bearing expansion lock in the second position; and

FIG. 8 is an exploded perspective view of another embodiment of a bearing expansion lock constructed in accordance with several features of the present invention.

### DETAILED DESCRIPTION OF THE INVENTION

A bearing expansion lock 10 is disclosed herein and in the various figures. The bearing expansion lock 10 of the present invention provides an improvement in a prior art tire building drum 12 which is useful in the manufacture of vehicle tires.

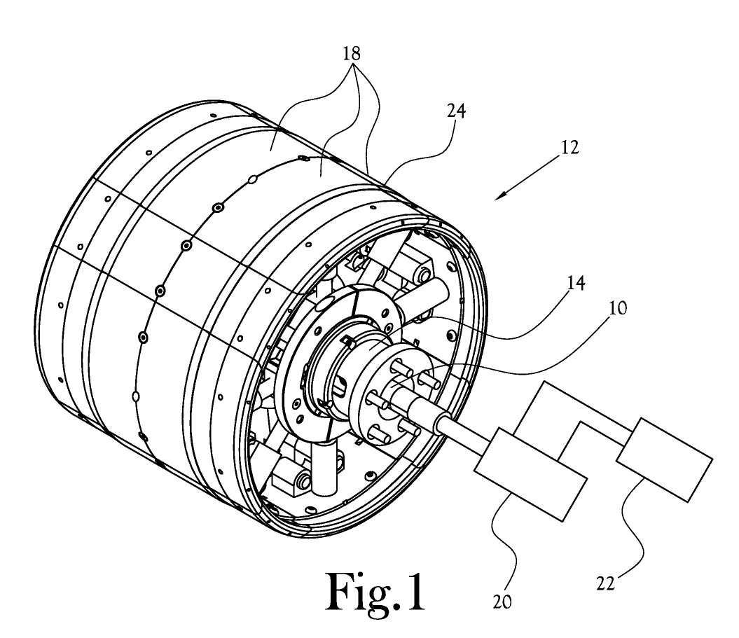

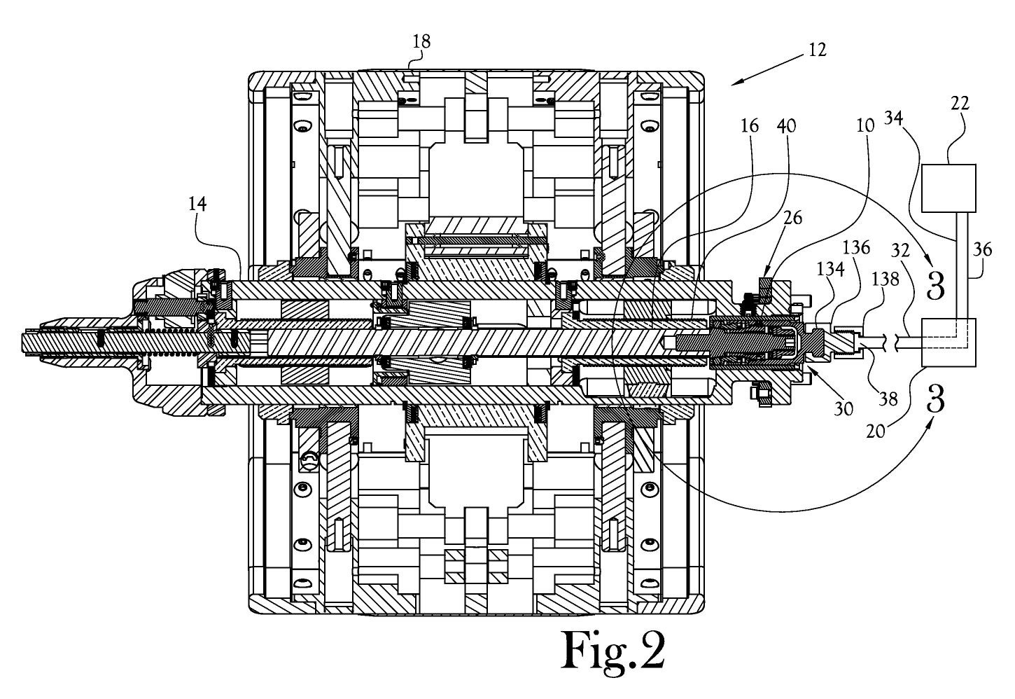

With initial reference to FIGS. 1 and 2, a tire building drum 12 is depicted. The tire building drum 12 is of the push-pull type wherein the drum is mounted for rotation on a central shaft 14. The shaft of the depicted drum is hollow and houses therein a push-pull rod 16 that is mechanically connected to a plurality of outer shell segments 18 (typical) which collectively define the outer circumferential working surface of the tire building drum 12. As discussed above, each segment is mounted for radial movement inwardly and outwardly of the tire building drum 12 upon actuation through linear axial movement of the push-pull rod 16. Actuation of the push-pull rod commonly is effected by means of a piston/cylinder device 20 that is powered from a source of pressurized fluid 22, most commonly pressurized air. When the push-pull rod 16 is pushed axially inwardly of the tire building drum 12 along the central shaft 14, the segments 18 simultaneously move radially outwardly of the tire building drum 12 to collectively define the outer circumferential surface 24 of the tire building drum 12. When the push-pull rod 16 is pulled in a direction outwardly of the tire building drum 12 along the central shaft 14, the segments 18 are moved radially inwardly of the tire building drum 12 to reduce its diameter, such as for removal of a formed toroidal tire carcass from the outer circumferential surface 24 of the tire building drum 12. U.S. Pat. No. 6,390,166 provides further structural and operational information relating to this type of tire building drum 12 and is incorporated herein in its entirety by reference.

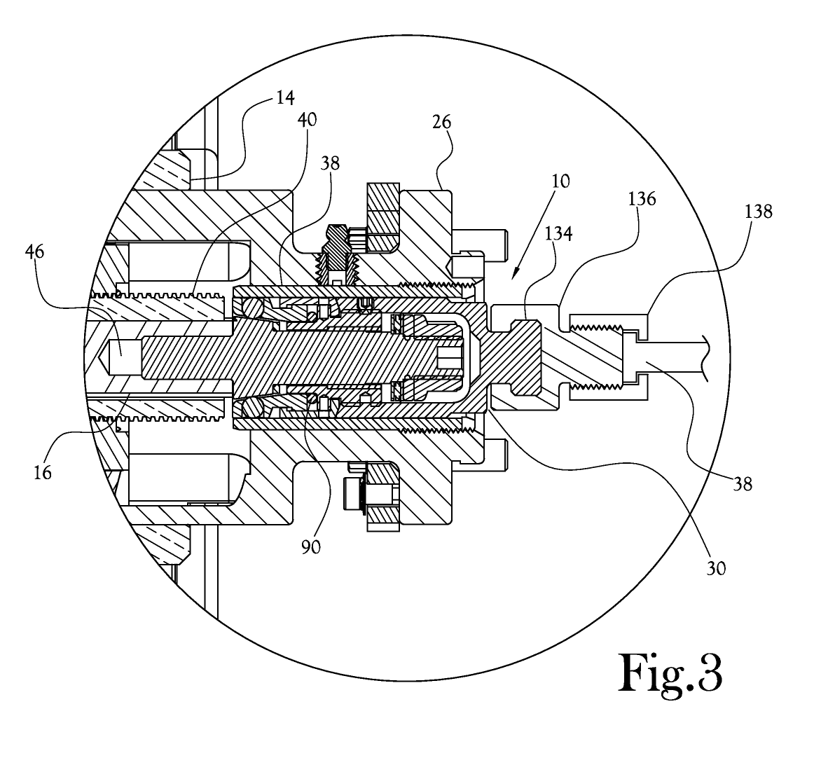

Referring to FIG. 2, in one embodiment of the present invention, the end 26 of the tire building drum 12 from which the push-pull rod 16 is accessible for operation of the push-pull rod 16 is provided with a bearing expansion lock 10 of the present invention. In the depicted embodiment, reciprocatory movement of the push-pull rod 16 is effected by means of a double-acting piston/cylinder 20 within which a piston 32 is reciprocatably mounted, and which is powered by the source 22 of pressurized fluid, commonly air, that is connected in fluid communication with the piston/cylinder as by conduits 34 and 36. Referring to FIGS. 2 and 3, in accordance with one aspect of the present invention, the bearing expansion lock 10 of the present invention is interposed between the outboard end 38 of the piston 32 and the outboard end 40 of the push-pull rod 16. This bearing expansion lock, or lock 10, generally comprises a shaft subassembly 30 which is slidably disposed within a cylindrical housing 38 mounted in the end 26 of the central shaft 14 of the tire building drum 12 (or the tire building drum housing, as appropriate) and which is anchored in the outboard end 40 of the push-pull rod 16.

Referring to FIGS. 3-7, the shaft subassembly 30 includes a shaft 42 having an externally threaded inboard end 44 adapted to be threadably received within a central internally threaded blind bore 46 provided in the outboard end 40 of the push-pull rod 16, and an externally threaded outboard end 48. In the illustrated embodiment, the shaft outboard end 48 is provided with at least one depression 50 adapted to receive a tool for threadably assembling the shaft inboard end 44 with the internally threaded blind bore 46 of the push-pull rod 16. Adjacent the shaft inboard end 44, the shaft 42 defines an annular circumferential flange 52 which extends substantially perpendicularly of the shaft 42. An outboard surface of the shaft flange 52 is beveled to define a tapered outer surface 56 thereon.

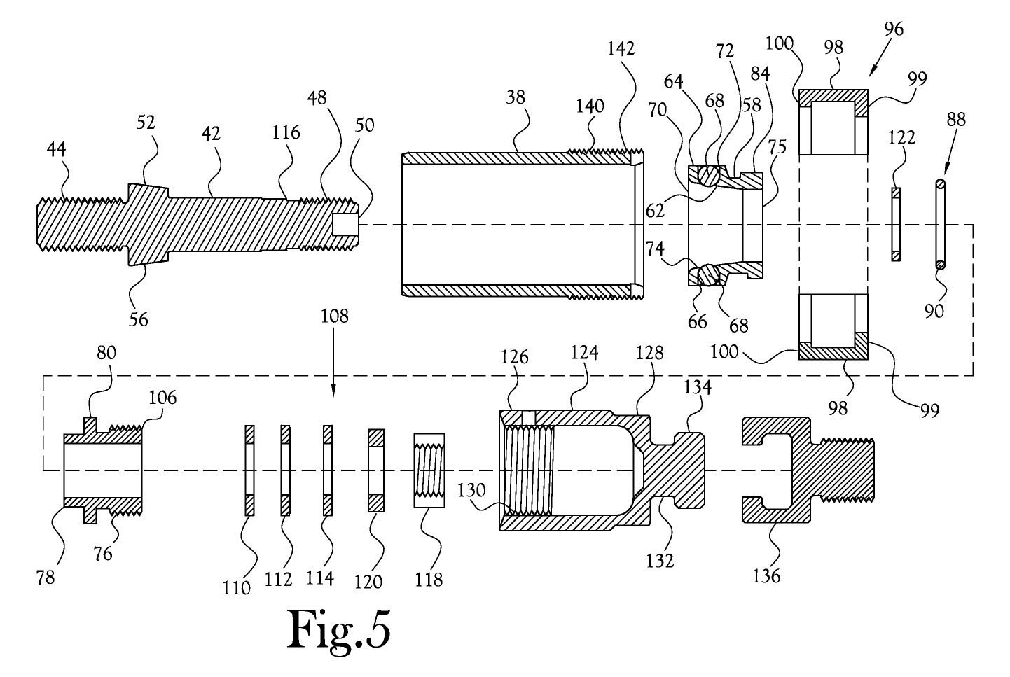

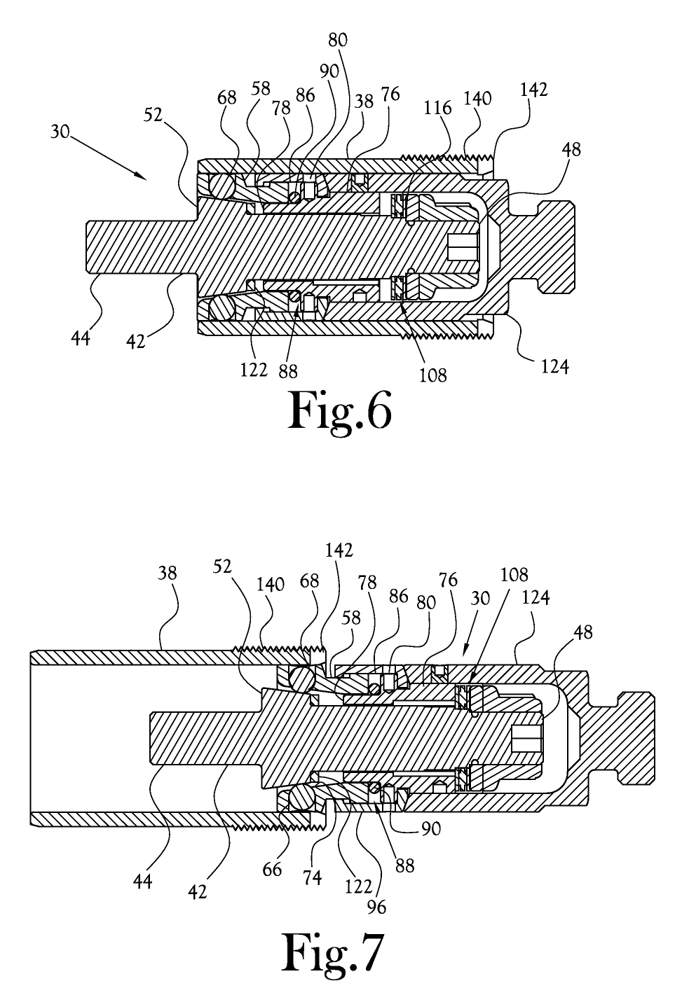

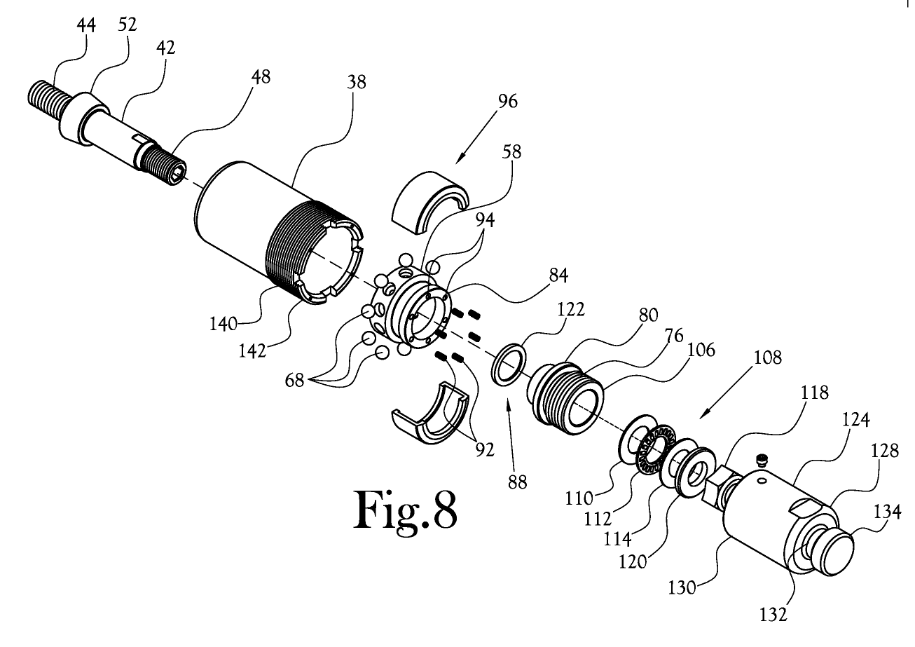

Between the shaft flange 52 and the shaft outboard end 48, there is provided an annular ball cage 58 which encircles the shaft 42 and carries an array of ball bearings 68 partially embedded therein. Referring to FIGS. 5-6, the ball cage 58 defines a generally cylindrical wall 64 defining an annular array of through cavities 66, each of which is sized to partially receive therein a ball bearing 68 (typical). Each through cavity 66 is contoured to permit a corresponding ball bearing 68 to project from both the interior surface 62 and exterior surface 72 of the ball cage 58, and each through cavity 66 is sized to allow radial inward and outward movement of its corresponding ball bearing 68 toward and away from the shaft 42. The wall 64 of the ball cage 58 is of a thickness less than the diameter of each ball bearing 68, such that radially outward movement of a ball bearing 68 to retract the ball bearing 68 from projection from the interior surface 62 of the ball cage 58 results in projection of the ball bearing 68 from the exterior surface 72 of the ball cage 58.

The interior surface 62 of the ball cage 58 is sized to permit slidable axial movement of the ball cage 58 along the shaft 42, and also to permit the shaft 42 to rotate within the ball cage 58, hence to rotate upon rotation of the push-pull rod 16 relative to the cylindrical housing 38, as needed. An inboard end 70 of the ball cage interior surface 62, including the portion of the interior surface 62 along the array of through cavities 66, is beveled to define a tapered inner surface 74 similar in dimension to the tapered outer surface 56 of the shaft flange 52. Thus, sliding movement of the ball cage 58 along the shaft 42 toward the shaft flange 52 brings the tapered outer surface 56 of the shaft flange 52 into close conformity with the tapered inner surface 74 of the ball cage 58, and thus into engagement with those portions of the ball bearings 68 projecting inwardly from the interior surface 62 of the ball cage 58 to bias the ball bearings 68 toward radially outward projection from the exterior surface 72 of the ball cage 58. Conversely, sliding movement of the ball cage 58 along the shaft 42 away from the shaft flange 52 produces a void space between the ball cage 58 and the shaft flange 52 interior of the ball cage 58 to permit radially inward projection of the ball bearings 68 from the interior surface 62 of the ball cage 58.

In the illustrated embodiment, an outboard end 75 of the ball cage 58 terminates at an outwardly extending annular circumferential flange 84. A bushing 76 is slidably positioned along the shaft 42 outboard of the ball cage 58 and extending inboard between the ball cage outboard end 75 and the shaft 42 to maintain coaxial alignment between the ball cage 58 and the shaft 42 and to enhance the rotational movement of the shaft 42 relative to the surrounding ball cage 58. An inboard end 78 of the bushing 76 defines a hollow cylindrical portion positioned along the non-tapered outboard portion of the ball cage interior surface 62 between the shaft 42 and the ball cage 58 to stabilize the relative positions of these components. In the illustrated embodiment, a cylindrical spacer 122 is provided between the bushing inboard end 78 and the shaft flange 52 to maintain proper spacing between the bushing 76 and the shaft flange 52 and to provide a bearing for rotational sliding movement between the shaft flange 52 and the bushing 76. In another embodiment, the bushing inboard end 78 extends sufficiently inboardly along the shaft 42 to maintain proper spacing between the bushing 76 and the shaft flange 52 through abutment of the bushing inboard end 78 with the shaft flange 52.

The bushing 76 further defines an outwardly extending annular circumferential flange 80 between the bushing inboard end 78 and an outboard end 82 of the bushing 76. The bushing flange 80 is positioned in substantially parallel, spaced apart relationship to the ball cage flange 84 to define an annular void 86 therebetween. A collar 96 is positioned surrounding opposite sides of the bushing flange 80 and the ball cage flange 84 to limit separation of the bushing 76 from the ball cage 58 along the axial dimension of the shaft 42. In the illustrated embodiment, the collar 96 is defined by a two-piece split collar defining a cylindrical body portion 98 surrounding the bushing flange 80, the ball cage flange 84, and the void 86. The collar 96 further defines an outboard, interiorly-extending circumferential wall 99 positioned outboard of the bushing flange 80, and an inboard, interiorly-extending circumferential wall 100 positioned inboard of the ball cage flange 84. In certain embodiments, the collar 96 is fixed in relation to at least one of the bushing 76 and the ball cage 58 as by set screws 102 received within appropriate through holes 104 defined in the collar 96. In other embodiments, the bushing 76 and the ball cage 58 are rotatably slidable within the collar 96 to further facilitate rotational movement of the push-pull rod 16 relative to the cylindrical housing 38, as needed.

In several embodiments, a resilient assembly 88 is disposed within the annular void 86 to bias the bushing flange 80 axially from the ball cage flange 84 within the collar 96. As will be discussed further below, the resilient assembly 88 serves to maintain controlled axial pressure between the bushing 76 and the ball cage 58 during reciprocatory movement of the push-pull rod 16 and lock 10 within the central shaft 14 of the tire building drum 12 to effect engagement of the shaft flange 52 with the ball bearings 68 and the tapered inner surface 74 of the ball cage 58. In the illustrated embodiment, the resilient assembly 88 is defined by an annular ring 90 formed of a resilient material surrounding the bushing inboard end 78 and interposed between the bushing flange 80 and the ball cage flange 84. In another embodiment, such as the embodiment of FIG. 7, the resilient assembly 88 is defined by a plurality of resiliently compressible springs 92 (typical) interposed between the bushing flange 80 and the ball cage flange 84. In the illustrated embodiment, each spring 92 is aligned axially along the shaft 42 and is partially received within corresponding cavities 94 defined along each of the bushing flange 80 and the ball cage flange 84 to maintain the springs 92 in a spaced apart relationship about the circumference of the void 86. Those skilled in the art will recognize other devices and configurations suitable for providing the resilient assembly 88 which may be used without departing from the spirit and scope of the present invention.

The ball cage 58, bushing 76, and collar 96 are, collectively, slidably movable along the shaft 42 between a first position, in which the tapered outer surface 56 of the shaft flange 52 abuts the portions of the ball bearings 68 protruding inwardly from the tapered inner surface 74 of the ball cage 58 to engage and bias the ball bearings 68 toward radially outward projection from the exterior surface 72 of the ball cage 58, and a second position, in which an outboard end 106 of the bushing 76 abuts a cylindrical bearing 108, comprising members 110, 112, and 114, which encircles the shaft 42 adjacent the outboard end 48 of the shaft 42, thereby providing a sliding seal between the outboard end 106 of the bushing 76 and the shaft 42 and limiting further outboard movement of the bushing 76 along the shaft 42. In the illustrated embodiment, the shaft 42 defines at least one circumferential lip 116 inboard of the shaft outboard end 48. The lip 116 is of a diameter slightly larger than an inner diameter of the bearing 108, such that the lip 116 retains the bearing 108 adjacent the outboard end 48 of the shaft 42. An internally threaded nut 118 is threadably received onto the externally threaded outboard end 48 of the shaft 42 to thereby capture and retain the various components of the bearing 108, ball cage 58, bushing 76, and collar 96 between the nut 118 and the shaft flange 52. In the illustrated embodiment, a washer 120 is provided between the nut 118 and the bearing 108 to effect more even load distribution and proper spacing between the nut 118 and the bearing 108. However, it will be understood that inclusion of the washer 120 is not critical to accomplishment of the present invention.

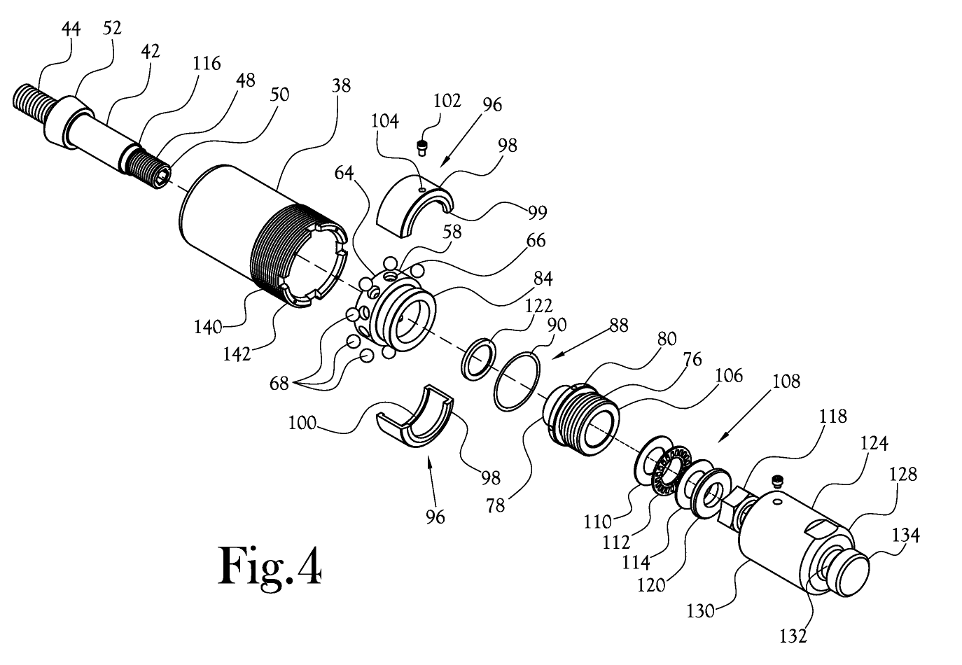

Referring to FIGS. 4-7, a cap 124 surrounds the shaft outboard end 48, nut 118, and bearing 108, and is secured to the outboard end 106 of the bushing 76. In the illustrated embodiment, the outboard end 106 of the bushing 76 defines an externally threaded cylindrical shape. The cap 124 includes a generally hollow cylindrical body portion 126 having an open, internally threaded inboard end 130 adapted to be threadably secured to the externally threaded bushing outboard end 106. An outboad end 128 of the body portion 126 is closed and has formed thereon an integral neck portion 132 which terminates in the form of an enlarged circumferential flange 134. As may be seen from FIGS. 2, 3, and 5, this flange 134 is designed to be received within a side-slotted connector 136 for operative connection of the cap 124 with the outboard end 38 of the reciprocatory rod 28 of the piston/cylinder device 20, for example, as by means of a threaded nut 138 or like fastener.

The shaft subassembly 30 is slidably received within the housing 38. As seen in FIGS. 2 and 3, the housing 38 is fitted within the end 26 of the hollow shaft 14 of the drum as by means of external threads 140 on an outboard end 142 of the housing being threadably received within mating internal threads provided within the hollow shaft 14 of the drum. As shown in FIGS. 6 and 7, the cap 124, collar 96, and ball cage 58 portions of the shaft subassembly 30 are each sized to be of a slightly smaller diameter than an inner diameter of the cylindrical housing 38. Thus, when the ball cage 58, bushing 76, and collar 96 are positioned in the second position (FIG. 7), allowing the ball bearings 68 to be received internally of the ball cage exterior surface 72, the shaft subassembly 30 is slidably disposed within the hollow cylindrical housing 38. However, with the shaft subassembly 30 received within the housing 38, movement of the shaft 42 in relation to the ball cage 58, bushing 76, and collar 96 toward the first position (FIG. 6) allows the tapered outer surface 56 of the shaft flange 52 to engage and bias the ball bearings 68 toward an interior surface 142 of the housing 38, thus allowing the ball bearings 68 to engage the housing interior surface 142 to simultaneously brace the shaft subassembly 30 centrally of the housing 38 and limit slidable movement of the shaft subassembly 30 in relation to the housing 38.

It is noted that, with the shaft inboard end 44 fixed in relation to the outboard end 40 of the push-pull rod 16, longtudinal movement of the shaft subassembly 30 within the housing 38 commences as the drum segments are moved between their radially outward and inward positions for defining and collapsing the outer circumferential working surface of the drum. In the illustrated embodiment, when the rod 28 of the piston/cylinder 20 is moved axially inwardly toward the tire building drum 12 along the central shaft 14, the rod 28 pushes against the shaft subassembly 30, which in turn pushes the push-pull rod 16 axially inwardly of the tire building drum 12 to simultaneously move the segments 18 radially outwardly of the tire building drum 12 to collectively define the outer circumferential surface 24 of the tire building drum 12. As this occurs, the shaft subassembly 30 slides within the housing 38 in the above-discussed second position of the shaft subassembly 30. Once the segments of the drum have been radially positioned outwardly of the drum in their desired locations to define the outer circumference of the drum, continued extension of the rod 28 and the shaft subassembly 30 along the housing 38 advances the ball cage 58, bushing 76, and collar 96 along the shaft 42 toward the first position. As the tapered outer surface 56 of the shaft flange 52 is brought into close conformity with the tapered inner surface 74 of the ball cage 58 to engage and bias the ball bearings 68 toward radially outward projection from the exterior surface 72 of the ball cage 58, continued extension of the cap 124 and bushing 76 along the shaft 42 pushes the bushing flange 80 toward the ball cage flange 84 to compress the resilient assembly 88 therebetween. Thereafter, axially inward movement of the rod 28 of the piston/cylinder 20 ceases.

In certain tire building apparatus in which actuation of the push-pull rod is effected by means of a piston/cylinder device 20 that is powered from a source of pressurized fluid 22, most commonly pressurized air, it is noted that discontinuing axially inward movement of the rod 28 through removal of pressure within the piston/cylinder 20 can result in a small axially outward movement of the rod 28 due, at least in part, to elastic strain in various components of the piston/cylinder device 20. Accordingly, in certain embodiments in which the resilient assembly 88 is compressed between the bushing flange 80 and the ball cage flange 84 during movement of the shaft subassembly 30 toward the first position, such small axially outward movement of the rod 28 results in partial decompression of the resilient assembly 88. Thus, as the resilient assembly 88 is partially decompressed, the resilient assembly 88 serves to maintain controlled axial pressure on the ball cage 58 along the shaft 42 toward the first position, thus maintaining pressure of the ball bearings 68 against the housing 38.

With the shaft subassembly 30 in the first position, resistance to withdrawal of the shaft subassembly 30 from along the housing 38 is provided by reason of the expansion of the bearings 68 within the housing 38. Thus, the segment-moving mechanism of the drum is locked against rebound due to, among other things, inadvertent or unintentional loss of the pressure employed to move the segments, and particularly any rebound due to lost motion in the overall mechanism, when the pressure applied to such mechanism to move the segments radially outward of the drum has been released. Withdrawal of the rod 28 outwardly from the tire building drum 12 pulls against the shaft subassembly 30 to first slide the ball cage 58, bushing 76, and collar 96 along the shaft 42 toward the first position to unlock the bearings 68 from engagement with the housing 38, and then to allow the push-pull rod 16 to slide axially outwardly of the tire building drum 12 to move the segments 18 radially inwardly of the tire building drum 12 to collapse the outer circumferential working surface of the drum.

From the foregoing description, it will be recognized by those skilled in the art that a bearing expansion lock has been provided which is useful in conjunction with a tire building drum in the manufacture of vehicle tires. While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A bearing expansion lock useful in locking axial movement of a push-pull rod driven by a potential energy source suitable for effecting linear axial movement of the push-pull rod, where the push-pull rod is housed in a hollow shaft, said bearing expansion lock comprising:
a hollow elongated housing adapted to be mounted along an axial dimension of the hollow shaft; and
a shaft subassembly received within said housing and adapted to be interposed between an outboard end of the push-pull rod and the potential energy source, said shaft subassembly being reconfigurable between a first position in which said shaft subassembly is braced against slidable movement within the housing along the hollow shaft and a second position in which said shaft subassembly is slidable within the housing along the central shaft;
whereby configuration of said shaft subassembly in said first position restricts movement of said shaft subassembly along said housing, thereby restricting movement of the push-pull rod along the hollow shaft.

2. The bearing expansion lock of claim 1, said shaft subassembly comprising:
a shaft having an inboard end and an outboard end, said shaft inboard end being adapted to be secured to the push-pull rod;
a circumferential flange extending from the shaft between the shaft inboard and outboard ends; and
a ball cage defining a plurality of through cavities, each said through cavity having a ball bearing at least partially embedded therein, said ball cage being slidably disposed along said shaft between said first position in which said flange engages at least one of said ball bearings to bias said ball bearing toward said housing and said second position in which said flange is disengaged from said at least one of said ball bearings.

3. The bearing expansion lock of claim 2, said plurality of through cavities being disposed in an annular array about said ball cage surrounding said shaft.

4. The bearing expansion lock of claim 2 further including an annular bushing surrounding said shaft, said bushing having a first end extending between said shaft and said ball cage and a second end extending along said shaft opposite said ball cage from said flange.

5. The bearing expansion lock of claim 4 further including a resilient assembly disposed between said ball cage and said bushing second end, said resilient assembly being compressible between said ball cage and said bushing second end to bias said ball cage toward said flange to maintain engagement of said flange with said at least one of said ball bearings in said first position.

6. The bearing expansion lock of claim 5, said resilient assembly including a resilient annular ring disposed surrounding said shaft between said ball cage and said bushing second end.

7. The bearing expansion lock of claim 5, said resilient assembly including a plurality of springs disposed surrounding said shaft between said ball cage and said bushing second end.

8. The bearing expansion lock of claim 7 wherein separation of said ball cage from said bushing second end along said shaft is restricted.

9. The bearing expansion lock of claim 7 further including a collar surrounding said resilient assembly to capture said resilient assembly between said ball cage and said bushing second end.

10. The bearing expansion lock of claim 9, said collar being defined by a split collar surrounding said resilient assembly and limiting separation of said ball cage from said bushing second end along said shaft.

11. The bearing expansion lock of claim 10 further including a cap having an inboard end secured to and surrounding said bushing second end and surrounding said shaft outboard end and an outboard end defining a connector adapted to secure said cap to the source of potential energy suitable for effecting linear axial movement of the push-pull rod.

12. The bearing expansion lock of claim 11, said connector being defined by a neck portion integrally formed with said cap outboard end and a circumferential flange defined at a terminus of said cap outboard end.

13. The bearing expansion lock of claim 11, said cap being sized to allow intimate slidable engagement with an interior surface of said housing.

14. The bearing expansion lock of claim 13, said ball cage and said collar each being sized to allow intimate slidable engagement with said interior surface of said housing.

15. The bearing expansion lock of claim 14, said housing interior surface defining a cylindrical shape.

16. In a rotatable drum useful in the manufacture of a vehicle tire or component thereof wherein the drum includes a housing and a plurality of outer circumferential surface-defining segments which are radially positionable relative to the rotational axis of the drum by means including linear axial movement of a push-pull rod housed within a central shaft by a potential energy source suitable for effecting linear axial movement of the push-pull rod, the improvement comprising:
a hollow elongated housing adapted to be mounted along an axial dimension of the central shaft; and
a shaft subassembly received within said housing and adapted to be interposed between an outboard end of the push-pull rod and the potential energy source, said shaft subassembly being reconfigurable between a first position in which said shaft subassembly is braced against slidable movement within the housing along the hollow shaft and a second position in which said shaft subassembly is slidable within the housing along the central shaft;
whereby configuration of said shaft subassembly in said first position restricts movement of said shaft subassembly along said housing, thereby restricting movement of the push-pull rod along the central shaft.

17. The drum of claim 16, said shaft subassembly comprising:
a shaft having an inboard end and an outboard end, said shaft inboard end being adapted to be secured to the push-pull rod;
a circumferential flange extending from the shaft between the shaft inboard and outboard ends; and
a ball cage defining a plurality of through cavities, each said through cavity having a ball bearing at least partially embedded therein, said ball cage being slidably disposed along said shaft between said first position in which said flange engages at least one of said ball bearings to bias said ball bearing toward said housing and said second position in which said flange is disengaged from said at least one of said ball bearings.

18. The drum of claim 17 further including an annular bushing surrounding said shaft, said bushing having a first end extending between said shaft and said ball cage and a second end extending along said shaft opposite said ball cage from said flange.

19. The drum of claim 18 further including a resilient assembly disposed between said ball cage and said bushing second end, said resilient assembly being compressible between said ball cage and said bushing second end to bias said ball cage toward said flange to maintain engagement of said flange with said at least one of said ball bearings in said first position.

20. The drum of claim 19 further including a collar surrounding said resilient assembly to capture said resilient assembly between said ball cage and said bushing second end and to limit separation of said ball cage from said bushing second end along said shaft.
